(19) United States
(12) Patent Application Publication
(10) Pub. No.: US 2008/0094671 A1
(43) Pub. Date: Apr. 24, 2008

(54) Image-data output system for a photosensor chip

(75) Inventors: Scott L. Tewinkle, Ontario, NY (US); Paul A. Hosier, Rochester, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/584,036

(22) Filed: Oct. 20, 2006

(51) Int. Cl. H04N 1/46

(52) U.S. Cl. 358/501

(57) ABSTRACT

A photosensor chip, such as used in a digital image scanner, includes a first contiguous subset of photosensors and a second contiguous subset of photosensors. Each subset of photosensors includes two interleaved (odd and even) groups of photosensors, outputting image data onto two multiplexed output channels. The image signals from each contiguous subset of photosensors are output through a common video line. Dividing the chip into first and second subsets of photosensors decreases total parasitic capacitance on the chip, and decreases the necessary number of transistors for readout.

### INCORPORATION BY REFERENCE

The following U.S. patent is incorporated by reference in its entirety for the teachings therein: U.S. Pat. No. 5,638,121.

### TECHNICAL FIELD

The present invention relates to image sensor arrays used in raster input scanners, such as used in digital copiers, or in any image-recording device such as a digital cameras.

### BACKGROUND

Image sensor arrays typically comprise a linear array of photosensors which raster scan an image-bearing document and convert the microscopic image areas viewed by each photosensor to image signal charges. Following an integration period, the image signal charges are amplified and transferred as an analog video signal to a common output line or bus through successively actuated multiplexing transistors.

For high-performance image sensor arrays, a preferred design includes an array of photosensors of a width comparable to the width of a page being scanned, to permit one-to-one imaging generally without the use of reductive optics. In order to provide such a “full-width” array, however, relatively large silicon structures must be used to define the large number of photosensors. A preferred technique to create such a large array is to make the array out of several butted silicon chips. In one proposed design, an array comprises of 20 silicon chips, butted end-to-end, each chip having 372 active photosensors spaced at 600 photosensors per inch.

U.S. Pat. No. 5,638,121, incorporated by reference above, describes a readout system for a CMOS-based photosensor chip, in which each photosensor is associated with its own individual transfer circuit, and sends image-based signals over time to an output line or video channel. In the '121 patent specifically, there are provided “odd” and “even” output lines, each line associated with the odd or even subset of photosensors along a linear array; using the two parallel video channels, image signals can be output by the chip at a high rate.

### SUMMARY

According to one aspect, there is provided an apparatus for outputting image data, comprising a first subset of photosensors, and a second subset of photosensors. Each of the first subset of photosensors and second subset of photosensors includes a first interleaved group of photosensors outputting signals to a first video channel and a second interleaved group of photosensors outputting signals to a second video channel. Circuitry outputs multiplexed image signals from the first video channel and second video channel of the first subset of photosensors and multiplexed image signals from the first video channel and second video channel of the second subset of photosensors to a common out line.

### BRIEF DESCRIPTION OF THE DRAWINGS

FIG. 1 is a simplified view of a multi-chip “full-width array” image sensor as would be used, for example, in a digital copier.

FIG. 2 is a schematic view showing the basic elements of an “odd-even” readout system as would be found on each chip in the bar shown in FIG. 1 as known in the prior art.

FIG. 3 is a schematic view of a single chip according to a new embodiment.

FIG. 4 is a schematic diagram of a set of flip-flops that operate the gates shown in FIG. 3.

FIG. 5 is a set of functional waveforms corresponding to points in the circuitry shown in FIG. 4.

### DETAILED DESCRIPTION

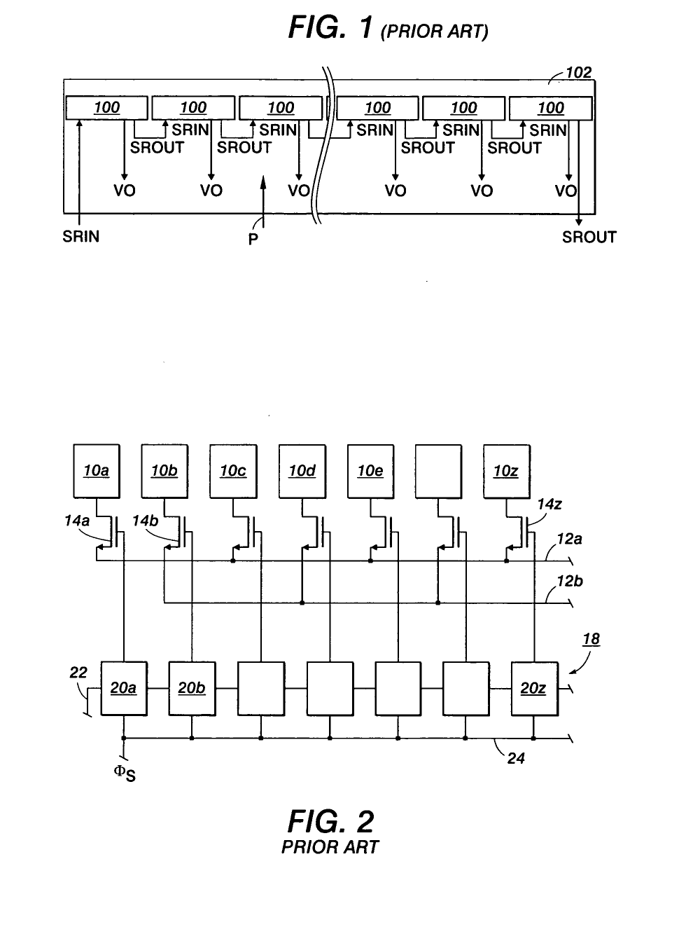

FIG. 1 is a simplified view of a multi-chip “full-width array” image sensor as would be used, for example, in a digital copier. A plurality of chips, here each indicated as 100, are arranged on a substrate 102, thus forming a bar that can extend the width of a sheet to be scanned or copied, such as in a digital copier. Each chip includes at least one linear array of photosensors (not shown in the Figure) with associated circuitry, and together the set of chips 100 can output image signals as though the chips formed a single linear array. In the context of an input scanner for a digital copier, a hard-copy image to be recorded would pass relative to the substrate 102 through process direction P; the photosensors on chips 100 record reflected light from a series of pixel-size areas on the moving sheet and output video signals over time, thus allowing the image on the sheet to be recorded in digital form. Each chip 100 includes a video out line VO for the output of video signals, as well as shift register lines SRIN and SROUT; as will be seen below, the shift register lines control the output of video signals from the photosensors.

FIG. 2 is a schematic view showing the basic elements of an “odd-even,” or “interleaved,” readout system as would be found on each chip 100 in the bar shown in FIG. 1 as known in the prior art; the circuitry and its principle of operation are described in more detail in the '121 patent. On a given chip such as 100, there is provided a set of photosensors 10a . . . 10z, which are connected by transistor switches 14a, 14b, etc. A shift register 18 which includes a set of half-stages 20a, 20b, etc., are arranged along a single line 22, and activated by a pixel clock line 24.

The linear array of photosensors 10a . . . 10z are arranged in an interleaved manner, with the odd subsets of photosensors such as 10a and 10c connected to an odd video line 12a, and the even photosensors such as 10b and 10d, connected to an even video line 12b. Video line 12a receives the video outputs only of the odd photosensors, and the even video line 12b receives the video outputs only of the even photosensors. Because both the odd and even photosensors are controlled by a single shift register 18, having half-stages 20a, 20b, etc., the video signals on odd video line 12a and even video line 12b can be output in parallel or multiplexed.

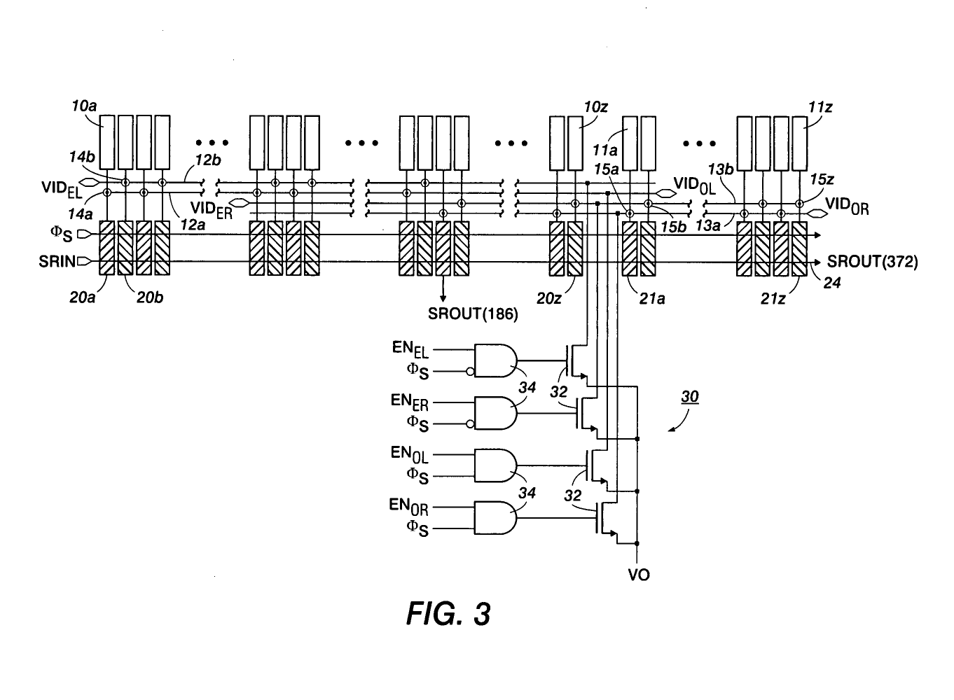

FIG. 3 is a schematic view of a single chip 100 according to a new embodiment. The basic “odd-even” readout principle, such as described with regard to FIG. 2, is evident; but, in this embodiment, the photosensors are further arranged into what can be called “left” and “right” subsets. In overview, the FIG. 3 embodiment provides, on each chip, two contiguous subsets of photosensors, and the subsets on each chip share a single “tap” through which video signals are output, including a common video out line VO. A “tap” can be defined as circuitry interposed between the subsets of photosensors and a video out line going off a chip. In one embodiment, the tap is disposed generally near a midpoint between the left and right subsets, and the signals from the odd and even lines associated with each subset are multiplexed by circuitry associated with the tap.

Looking at FIG. 3 in more detail, it can be seen that the photosensors 10a . . . 10z with their associated switches 14a . . . 14z, output video signals over time onto the respective odd and even video lines 12a and 12b, controlled by the associated shift register stages 20a . . . 20z, just like the FIG. 2 embodiment described above. However, the photosensors 10a . . . 10z form only one contiguous subset of photosensors on the chip 100, in this case only the “left side” of the chip 100. On the right side of the chip 100 is disposed a second contiguous subset of photosensors, indicated as 11a . . . 11z. This second contiguous subset 11a . . . 11z with associated switches 15a . . . 15z, outputs video signals over time onto the respective odd and even video lines 13a and 13b, controlled by the associated shift register stages 21a . . . 21z, in the same manner as the first contiguous subset 10a . . . 10z.

The odd and even output lines, or channels, 12a and 12b from the left side, and the odd and even output lines, or channels, 13a and 13b from the right side direct their output signals to a tap generally indicated as 30, which is in the embodiment disposed near or at the midpoint of the chip. A set of switches 32, controlled by a corresponding set of gates 34, operate to multiplex the four lines to the single video out line VO (which can be seen associated with each chip 100 in FIG. 1). As shown in the Figure, the inputs to the gates 34 include a pixel clock stages φS and a set of enable signals EN_{EL} (even, left), EN_{ER} (even, right), EN_{OL} (odd, left), and EN_{OR} (odd, right). Each enable signal, when high, causes its corresponding output line (12a, 12b, 13a, 13b) to output its current video signals onto video output VO for the whole chip 100.

In operation, for each cycle of operation (i.e., reading out image data for a “line” of pixels, while a sheet is moving through process direction P), within each chip 100, the left subset (photosensors 10a . . . 10z) outputs its video signals in odd-even fashion through video out line VO; then, after the left subset, the right subset (photosensors 11a . . . 11z) outputs its video signals in odd-even fashion through video out line VO. According to this operation, for each chip 100, only two photosensors are “active” (outputting signals) at any given time. As mentioned in U.S. Pat. No. 5,638,121, referenced above, the odd-even readout in general allows for a speedy readout time because it allows the early settling time of each video signal readout (which is not a useful signal) to be ignored; that is, while an odd photosensor is still settling to its true value, the final, settled video value of a neighboring even photosensor can be read out, and vice-versa. It should be noted that the odd-even readout technique applies in the embodiment only to the readout within each contiguous subset: readouts from the left subset and the right subset are not multiplexed together.

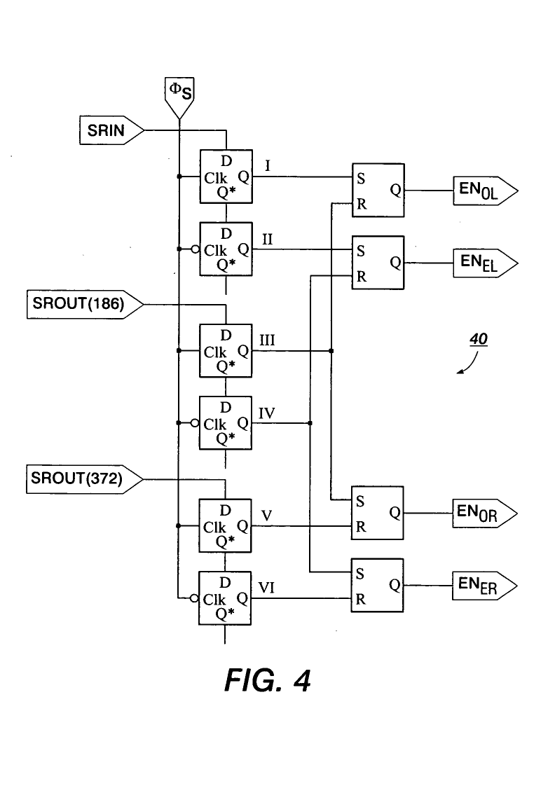

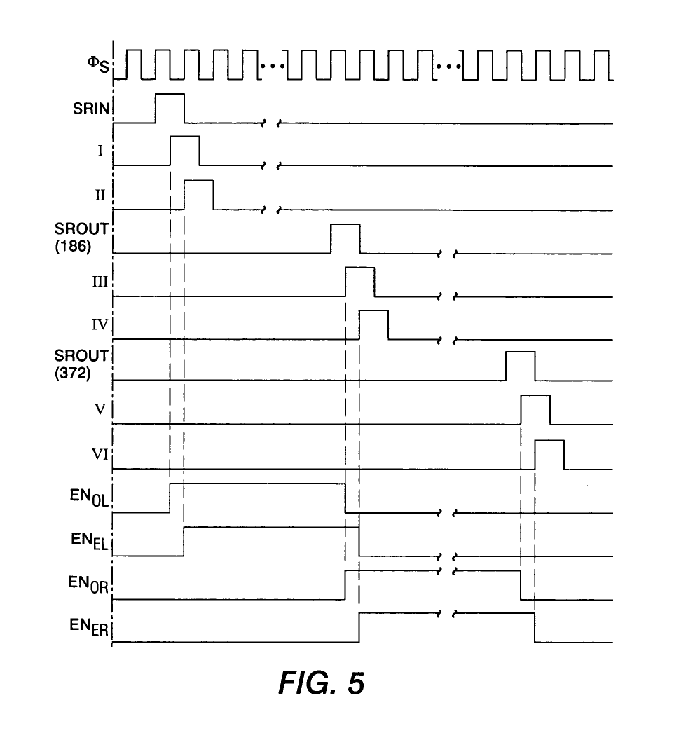

FIG. 4 is a schematic diagram of a set 40 of flip-flops that operate the gates 34 shown in FIG. 3. FIG. 5 is a set of functional waveforms corresponding to points in the circuitry shown in FIG. 4. In the Figures, the waveforms for the pixel clock φS and the shift register in signal SRIN typically originate off a chip 100, while SROUT(186) corresponds to the output of the shift register stage 14z, corresponding to the last photosensor 10z in the left subset of photosensors. (In one practical embodiment, there are 186 photosensors in the linear array forming the left subset.) SROUT(372) corresponds to the output of the shift register stage 15z, corresponding to the last photosensor 10z in the right subset of photosensors.

The practical advantages of the FIG. 3 embodiment include a reduction of parasitic capacitance along signal output lines, relative to an equivalent chip not having the described features, because the output lines in the FIG. 3 embodiment are shorter. The configuration also reduces the number of necessary video line switches relative to an equivalent chip not having the described features.

In various possible embodiments, each photosensor such as 10a or 11a can be associated with multiple addressable photosensors, such as in a full-color scanner in which there are provided differently-filtered photosensors in each set, or in a two-dimensional array. It is also conceivable, within each subset, to have “interleaved” photosensors beyond odd and even, e.g., having four interleaved sets of photosensors outputting onto four parallel lines.

Although the described embodiment shows analog signals being output on the video out line VO, alternate embodiments can include analog-to-digital conversion circuitry so that digital image-based signals are output by the chip.

While it is generally desirable, from the standpoint of reducing total parasitic capacitance, to have the two contiguous subsets of photosensors have at least roughly an equal number of photosensors, different specific designs for various purposes may mandate significantly different numbers of photosensors in each subset.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

1. An apparatus for outputting image data, comprising:
a first subset of photosensors, and a second subset of photosensors;
each of the first subset of photosensors and- second subset of photosensors including a first interleaved group of photosensors outputting signals to a first video channel and a second interleaved group of photosensors outputting signals to a second video channel; and
circuitry for outputting multiplexed image signals from the first video channel and second video channel of the first subset of photosensors and multiplexed image signals from the first video channel and second video channel of the second subset of photosensors to a common out line.

2. The apparatus of claim 1, the first subset of photosensors and second subset of photosensors each forming a contiguous subset of photosensors.

3. The apparatus of claim 1, the first subset of photosensors and second subset of photosensors together forming at least one linear array.

4. The apparatus of claim 1, the first subset of photosensors and second subset of photosensors occupying a chip.

5. The apparatus of claim 4, further comprising a tap disposed on the chip, the tap including at least some of the circuitry.

6. The apparatus of claim 4, the tap being disposed substantially between the first subset of photosensors and second subset of photosensors.

7. The apparatus of claim 1, the circuitry enabling, with each cycle of operation for recording a line of data, image signals from the first subset of photosensors to be output on the out line, and then image signals from the second subset of photosensors to be output on the out line.
